(19) United States
(12) Patent Application Publication
(10) Pub. No.: US 2026/0342934 A1
(43) Pub. Date: Oct. 29, 2026

(54) COLOR MEASUREMENT SYSTEM, COLOR MEASUREMENT METHOD, AND NON-TRANSITORY COMPUTER-READABLE STORAGE MEDIUM STORING CONTROL PROGRAM

(71) Applicant: KONICA MINOLTA, INC., Tokyo (JP)

(72) Inventor: Keita Kano, Tokyo (JP)

(73) Assignee: KONICA MINOLTA, INC., Tokyo (JP)

(21) Appl. No.: 19/395,633

(22) Filed: Nov. 20, 2025

(30) Foreign Application Priority Data
Dec. 9, 2024 (JP) 2024-214417

(51) Int. Cl. H04N 1/60; H04N 1/50

(52) U.S. Cl. CPC H04N 1/6044; H04N 1/50

(57) ABSTRACT

A color measurement system includes: an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement; a sheet information acquirer that acquires sheet information about the sheet to be subjected to color measurement; a storage that stores color measurement information obtained by the color measurement by the image color measurement section in association with the sheet information as history data; and a hardware processor that, when receiving a color measurement instruction, determines whether or not the color measurement by the image color measurement section is necessary based on the sheet information about the sheet to be subjected to the color measurement and the history data.

### CROSS-REFERENCE TO RELATED APPLICATION

The entire disclosure of Japanese patent application No. 2024-214417, filed on Dec. 9, 2024, is incorporated herein by reference in its entirety.

### BACKGROUND OF THE INVENTION

### 1. Technical Field

The present invention relates to a color measurement system, a color measurement method, and a non-transitory computer-readable storage medium storing a control program.

### 2. Description of Related art

In recent years, in an image forming system including an image forming apparatus and an image reading device, the image reading device that reads an image formed on a sheet (storage medium) in the image forming apparatus includes a scanner that is provided in a conveyance route of the sheet for reading a color measurement patch on the sheet and a colorimeter that is provided in the conveyance route of the sheet for measuring the color of the color measurement patch on the sheet.

Japanese Unexamined Patent Application Publication No. 2018-61099 discloses an image forming apparatus including a scanner capable of reading an image on the entire surface of a sheet and a colorimeter that is fixedly disposed and that measures a color only in a partial region (central part in the width direction) of the surface of the sheet. This image forming apparatus uses a technique (simple color measurement) for efficiently performing color measurement using a scanner. Specifically, a reading region by the scanner and a color measurement region by the colorimeter are separated, color measurement patches in the same color are arranged, RGB (red, green, blue) values read by the scanner are converted into L*a*b* and the converted L*a*b* is corrected with L*a*b* obtained by reading a color measurement patch in the same color by the colorimeter.

Japanese Unexamined Patent Application Publication No. 2024-085279 discloses an image forming system equipped with a colorimeter that can measure the color of the entire surface of a sheet by moving the colorimeter in a direction orthogonal to the conveyance direction of the sheet and conveying the sheet to scan the entire surface of the sheet. In the image forming system disclosed in Japanese Unexamined Patent Application Publication No. 2024-085279, color measurement (high-precision color measurement) of the entire surface of a sheet is achieved by repeating the steps of stopping the sheet, on which many patch images are formed by an image former on the upstream side, at a measurement position, performing multipoint color measurement while moving a colorimeter in the width direction, slightly moving the sheet in the conveyance direction, and then performing multipoint color measurement again.

When the above-described high-precision color measurement is performed, it takes about several tens of minutes to perform a series of color measurement processes.

Therefore, if the above-described high-precision color measurement is constantly performed, productivity greatly decreases.

In Japanese Unexamined Patent Application Publication No. 2024-085279, the following processing is performed in order to achieve both productivity and highly accurate color management.

That is, reading by a scanner capable of measuring a color in a short time is first performed, and when color variation equal to or larger than a predetermined value is detected in the reading result, high-precision color measurement is performed on the entire surface of the sheet by an image color measurement section.

### SUMMARY OF THE INVENTION

However, when executing a job, the image forming system disclosed in Japanese Unexamined Patent Application Publication No. 2024-085279 needs to always print an image to be analyzed by the scanner in order to determine the necessity of color measurement by the image color measurement section, and this leads to a problem of an increase in consumption of resources such as sheet and toner.

Furthermore, there is a problem in that, after the image is read by the scanner, analysis processing for determining, from a reading result, whether or not color measurement is necessary becomes a load on the system.

The present invention has been made in consideration of the above-described circumstances, and an object thereof is to appropriately determine the necessity of color measurement by a color measurement section while suppressing consumption of resources and a load on a system.

To achieve at least one of the abovementioned objects, according to an aspect of the present invention, a system reflecting one aspect of the present inventions comprises the followings.

A color measurement system including:
an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement; a sheet information acquirer that acquires sheet information about the sheet to be subjected to color measurement;
a storage that stores color measurement information obtained by the color measurement by the image color measurement section in association with the sheet information as history data; and
a hardware processor that, when receiving a color measurement instruction, determines whether or not the color measurement by the image color measurement section is necessary based on the sheet information about the sheet to be subjected to the color measurement and the history data.

### BRIEF DESCRIPTION OF THE DRAWINGS

The advantages and features provided by one or more embodiments of the present invention will be more fully understood from the following detailed description and the accompanying drawings. It is to be noted that these are for purposes of illustration only and are not intended to limit the present invention.

FIG. 1 is a diagram illustrating a schematic configuration of a color measurement system according to the present embodiment;

FIG. 2 is a block diagram of the color measurement system;

FIG. 3 is a table for describing sheet information associated with a sheet feed tray;

FIG. 4 is a schematic perspective view illustrating a configuration of an image color measurement section;

FIGS. 5A and 5B are schematic diagrams for describing a first color measurement mode;

FIGS. 6A and 6B are schematic diagrams for describing a second color measurement mode;

FIG. 7 is a table illustrating history data;

FIG. 8 is a table illustrating color measurement information;

FIG. 9 is a table illustrating color measurement execution information;

FIG. 10A is a flowchart illustrating a color measurement method;

FIG. 10B is a flowchart to be executed subsequent to FIG. 10A;

FIG. 11 is an example of an operation screen for receiving various kinds of color measurement execution information;

FIG. 12 is an example of an operation screen for receiving reuse of matching history data; and

FIG. 13 is an example of an operation screen for receiving a selection of whether or not the color measurement is performed.

### DETAILED DESCRIPTION

An embodiment of the present invention will be described below with reference to the accompanying drawings. It is to be noted that the scope of the present invention is not limited to the disclosed embodiment. Note that in the description of the drawings, the same components are denoted by the same symbol, and redundant descriptions are omitted. In addition, dimensional ratios in the drawings are exaggerated for convenience of description and may be different from actual ratios. In the drawings, a top-bottom direction (vertical direction) is defined as a Z direction, a front direction and a rear direction of a color measurement system are defined as a Y direction, and a direction orthogonal to the Y and Z directions is defined as an X direction. The X direction is also referred to as a conveyance direction of a sheet. The Y direction is also referred to as a width direction (or a CD direction). In the present embodiment, the sheet includes a printing sheet (hereinafter simply referred to as sheet) and various films. In particular, the sheet includes a sheet produced using mechanical pulp and/or chemical pulp that are derived from plants. Examples of the types of sheets include coated glossy paper, coated matte paper, and uncoated paper such as plain paper and high-quality paper.

Although an electrophotographic method using toner will be described below as an example of a method of an image forming apparatus, another method such as an inkjet method may be applied.

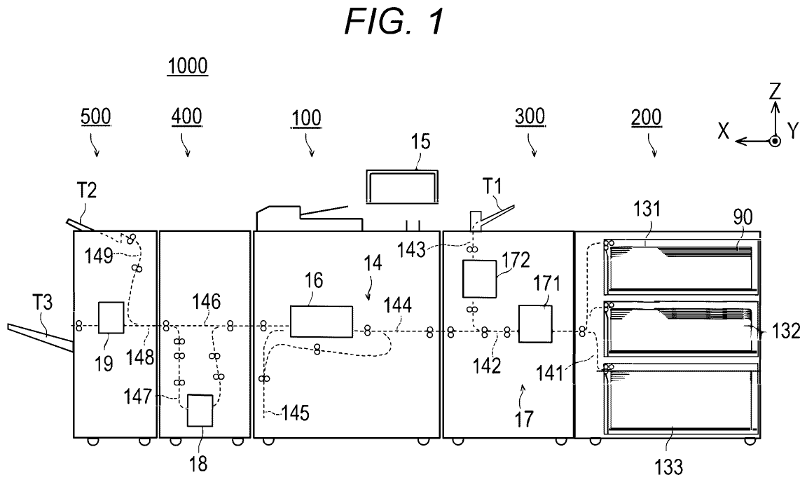

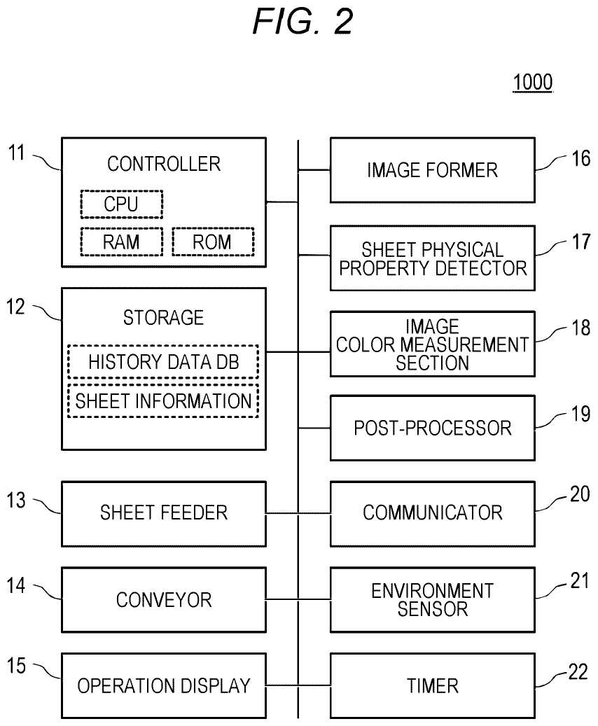

FIG. 1 is a diagram illustrating a schematic configuration of a color measurement system 1000 according to the present embodiment. FIG. 2 is a block diagram illustrating a hardware configuration of the color measurement system 1000. As illustrated in FIG. 1, the color measurement system 1000 includes an image forming apparatus 100, a sheet feed device 200, a sheet physical property detection device 300, a color measurement device 400, and a post-processing device 500, which are mechanically and electrically connected to each other. The color measurement system 1000 is connected to a terminal device such as a PC.

### Image Forming Apparatus 100

The image forming apparatus 100 forms an image on a sheet 90 sent from the sheet physical property detection device 300 located on an upstream side.

### Sheet Feed Device 200

The sheet feed device 200 includes a plurality of sheet feed trays 131 to 133 and feeds the uppermost sheet of a sheet bundle stored in the sheet feed trays 131 to 133 or the like one by one according to the setting of a print job. The fed sheet is conveyed to the sheet physical property detection device 300 on the downstream side for the measurement of the physical property of the sheet, and is conveyed to the image forming apparatus 100 on the further downstream side for the formation of an image. A plurality of sheet feed devices 200 can be connected, and two or three sheet feed devices can be connected on the upstream side.

### Sheet Physical Property Detection Device 300

The sheet physical property detection device 300 includes a sheet physical property detector 17, and detects the sheet physical property of the conveyed sheet by the sheet physical property detector 17. The sheet physical property detector 17 includes a first detector 171 disposed on a conveyance path 142 and a second detector 172 disposed on a conveyance path 143 on the downstream side of the first detector 171. These detectors will be described in detail later.

### Color Measurement Device 400

The color measurement device 400 includes an image color measurement section 18, and measures the color of a patch image formed on the sheet 90 conveyed to a branched conveyance path 147 when a color measurement mode (first or second color measurement mode to be described later) is executed. The details of the image color measurement section 18 will be described later.

### Post-Processing Device 500

The post-processing device 500 performs post-processing on the sheet 90 sent from the image forming apparatus 100 or ejects the sheet 90 according to the setting of the print job. The post-processing device 500 includes a plurality of sheet ejection trays T2 and T3. The sheet ejection trays T2 and the T3 are selected according to the setting of the print job. The sheet 90 on which the patch image has been formed and which has been subjected to the color measurement due to the execution of the color measurement mode is ejected to the sheet ejection tray T2 through a conveyance path 149, for example. A post-processor 19 performs at least one of stapling, punching, cutting, folding, or bookbinding on the sheet 90 on which an image has been formed.

As illustrated in FIG. 2, the color measurement system 1000 includes a controller (hardware processor) 11, a storage 12, a sheet feeder 13, a conveyor 14, an operation display 15, an image former 16, the sheet physical property detector 17, the image color measurement section 18, the post-processor 19, a communicator 20, an environment sensor 21, and a timer 22.

### Controller 11

The controller 11 includes a CPU, a ROM, a RAM, and the like. The controller 11 executes various kinds of processing by executing programs stored in the ROM and the storage 12, and controls components of the apparatus and executes various kinds of calculation processing in accordance with the programs. FIG. 2 illustrates an example in which one controller 11 is provided in the image forming apparatus 100, but the controller 11 may be disposed in each of the apparatus 100 and the devices 200 to 500. Similarly, the storage 12 and the communicator 20 described below may be disposed in each of the apparatus 100 and the devices 200 to 500.

### Storage 12

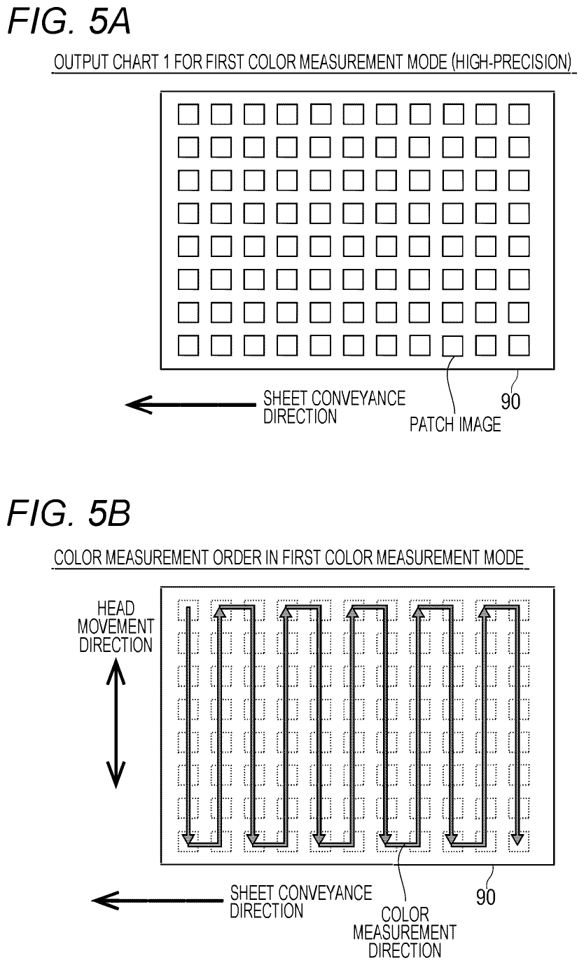

The storage 12 includes an auxiliary storage such as a hard disk that stores various kinds of programs and various kinds of data. The storage 12 stores sheet information regarding sheets stored in each sheet feed tray. The storage 12 also stores a history data database (DB) in which a plurality of pieces of history data is stored. The details thereof will be described in detail later. Furthermore, the storage 12 stores a paper profile, which will be described later, and a color measurement chart (also referred to as an output chart) for color measurement (see FIG. 5A and the like to be described later).

### Sheet Feeder 13

Referring to FIGS. 1 and 2, the sheet feeder 13 includes a plurality of sheet feed trays, and feeds the sheets 90 stored in the sheet feed trays one by one to send the sheets 90 to a conveyance path of the conveyor 14.

The conveyor 14 includes conveyance paths 141 to 149 disposed in the apparatus 100 and devices 200 to 500. The conveyor 14 includes sheet detection sensors disposed on the conveyance paths 141 to 149, a plurality of conveyance rollers, and drive motors (none of which are illustrated) that drive these conveyance rollers.

### Operation Display 15

The operation display 15 includes a touch screen, a numeric keypad, a start button, a stop button, and the like. The operation display 15 displays a state of the image forming apparatus 100 or the color measurement system 1000, and is used for input of settings for the type of sheet placed on the sheet feed tray or the like and instructions for the color measurement from a user. In the present embodiment, the sheet physical property detector 17 and/or the operation display 15 to which sheet information is input by the user function as a sheet information acquirer.

### Image Former 16

The image former 16 is disposed inside the image forming apparatus 100. The image former 16 forms an image on the sheet conveyed through the conveyance path 144 with, for example, an electrophotographic method. The image former 16 includes writing sections and photosensitive drums respectively corresponding to basic colors of yellow (Y), magenta (M), cyan (C), and black (K), and developing devices each accommodating a two-component developer including toner of the corresponding color and a carrier. The image former 16 further includes an intermediate transfer belt, a secondary transferer, and a fixer. Toner images formed on the photosensitive drums by the developing devices of the respective colors are superimposed on the intermediate transfer belt, and are transferred onto the conveyed sheet 90 at the secondary transferer. The toner image on the sheet 90 is fixed on the sheet 90 by being heated and pressed by the fixer on a downstream side. In double-sided printing in which an image is also formed on the back surface of the sheet 90, the sheet 90 on which an image has been formed on one side is conveyed to the conveyance path 145 for double-sided image formation in a lower portion of the apparatus body. The sheet 90 conveyed to the conveyance path 145 is turned over on a switchback path and then is conveyed to the conveyance path 144 for single-sided printing which is a main conveyance path, and an image is again formed on the other side of the sheet 90 by the image former 16.

### Sheet Physical Property Detector 17

The sheet physical property detector 17 is disposed in the sheet physical property detection device 300. The sheet physical property detector 17 includes a plurality of sensors, and includes the first detector 171 disposed on the conveyance path 142 and the second detector 172 disposed on the conveyance path 143 on the downstream side of the first detector 171. The conveyance path 143 is a conveyance path that is branched from the main conveyance path 142, and the sheet 90 detected by the second detector 172 is ejected to the ejection tray T1 (hereinafter, also referred to as a purge tray) on the upper side.

A plurality of sensors 1 to 3 disposed in the first detector 171 detects a sheet thickness, a basis weight, and a moisture content, or physical property values corresponding thereto, respectively. These sensors disposed in the first detector 171 detect various sheet physical properties while conveying the sheet 90 without stopping the conveyed sheet 90.

The “sheet thickness” is acquired by the sensor 1 detecting a characteristic corresponding to the thickness of the sheet. The sensor 1 holds a sheet between two members such as a pair of conveyance rollers and measures the distance between the two members.

The “basis weight” is acquired by the sensor 2 detecting a characteristic corresponding to the basis weight of the sheet. The sensor 2 is, for example, a transmission-type or reflection-type optical sensor. The basis weight is acquired by measuring an attenuation amount (transmittance) of light transmitted through the sheet with the sensor 2.

The “moisture content” is acquired by the sensor 3 detecting a characteristic corresponding to the moisture content (also referred to as water content) of the sheet. The sensor 3 optically detects, for example, an amount of light absorbed by an OH group with a near-infrared method on the basis of light transmitted through the sheet.

A plurality of sensors 4 to 6 disposed in the second detector 172 detects stiffness, a surface property, and a sheet resistance (electrical resistance), or physical property values corresponding thereto, respectively. These sensors disposed in the second detector 172 detect various sheet physical properties while temporarily stopping each of the conveyed sheets 90 at a detection position.

The “stiffness” is acquired by the sensor 4 detecting a characteristic corresponding to the stiffness of the sheet. The sensor 4 measures a pressing force applied to a trailing end of the sheet as a free end. The “stiffness” indicates a value related to a sheet bending strength.

The “surface property” is acquired by the sensor 5 detecting a characteristic corresponding to the smoothness of the surface property of the sheet. The “surface property” is also referred to as the smoothness. The sensor 5 includes an irradiator and a light receiver. For example, the sensor 5 irradiates the surface of the sheet with light at an incident angle of 75 degrees, and optically detects specular reflection light and diffuse reflection light from the surface of the sheet by two sensors. The “surface property” indicates a value related to a sheet surface condition.

The “sheet resistance” is acquired by the sensor 6 detecting a characteristic corresponding to the electrical resistance of the inside or the surface of the sheet. The sensor 6 measures a voltage and a flowing current when a high voltage is applied to the sheet. The “sheet resistance” indicates a value related to a sheet volume resistance.

The number of sensors included in the sheet physical property detector 17 is not limited to six, and other sensors for detecting sheet physical properties may be included, or some of the sensors may be omitted. For example, a line sensor that optically detects the size (shape) of the sheet 90 by detecting the entire region in the sheet width direction as a detection region may be included.

### Sheet Type Determination Processing

The sheet 90 is conveyed from a target sheet feed tray (for example, the sheet feed tray 131), and the sheet physical properties are measured by the sheet physical property detector 17. The sheet physical properties to be measured include the sheet physical properties acquired by the respective sensors described above. For example, the controller 11 determines a sheet type and a basis weight category based on the obtained plurality of sheet physical properties, such as a basis weight, a sheet thickness, and a surface property. The sheet type includes plain paper, high-quality paper, and coated paper as categories. The sheet type and the basis weight category may be determined using a rule-based method. That is, the sheet type and the basis weight category may be determined using a trained model (sheet type determination engine) and a paper profile. In the “paper profile”, a measurement value of a certain sheet measured by the sheet physical property detector 17 and characteristic data, a sheet size, and an optional identification name (for example, a sheet brand) of the certain sheet input from a user are registered in advance in association with each other. The sheet brand is obtained by specifying the brand of a paper manufacturer and further subdividing the sheet type, and when the sheet brand is specified, the sheet type is specified. The “sheet type determination engine”, which is also referred to as a trained model, is a trained model generated by supervised learning using training data with the output of the sheet physical property detector 17 for the sheet 90 as an input value and the sheet type information regarding the sheet 90 set by the user as a ground truth label. After the sheet type and the basis weight category are determined by the controller 11, the determination result is displayed on the operation display 15. When the user confirms the determination results (a confirmation button), the determination results are fixed and the sheet feed tray and the information regarding the sheet type are stored in the storage 12 in association with each other.

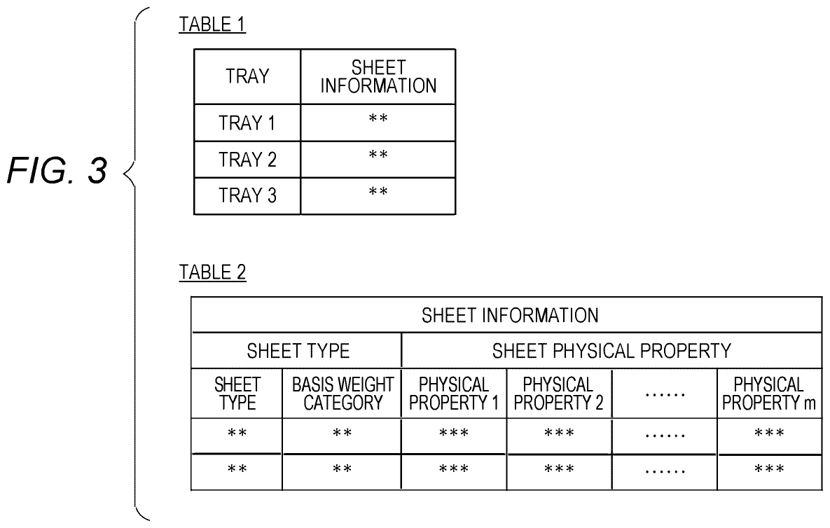

FIG. 3 is a diagram for describing sheet information associated with a sheet feed tray. Table 1 in FIG. 3 illustrates sheet information associated with sheet feed trays. Table 2 illustrates the detail of the sheet information. The sheet information includes data about the sheet physical properties 1 to 6 detected by the sheet physical property detector 17. The sheet type is the one determined by the above-described sheet type determination processing from the data about the sheet physical properties, or the one input by the user through the operation display 15. The setting of the sheet type and the detection of the sheet physical properties are performed when the sheet physical property detector 17 detects the sheet physical properties automatically in response to an instruction from the user through the operation display 15 or each time a new sheet is loaded in the sheet feed tray. The sheet 90 used for the detection is ejected to the ejection tray T1.

### Image Color Measurement Section 18

The image color measurement section 18 is disposed in the color measurement device 400. The color measurement device 400 is provided with a conveyance path 146 that is a main conveyance path and a U-shaped conveyance path 147 that is branched downward therefrom. When color measurement is not performed, for example, during normal image formation, the sheet 90 is sent to the post-processing device 500 on the downstream side through the conveyance path 146. On the other hand, at the time of color measurement, the sheet 90 is conveyed to the branched conveyance path 147, and the color measurement is performed by the image color measurement section 18 disposed on the conveyance path 147.

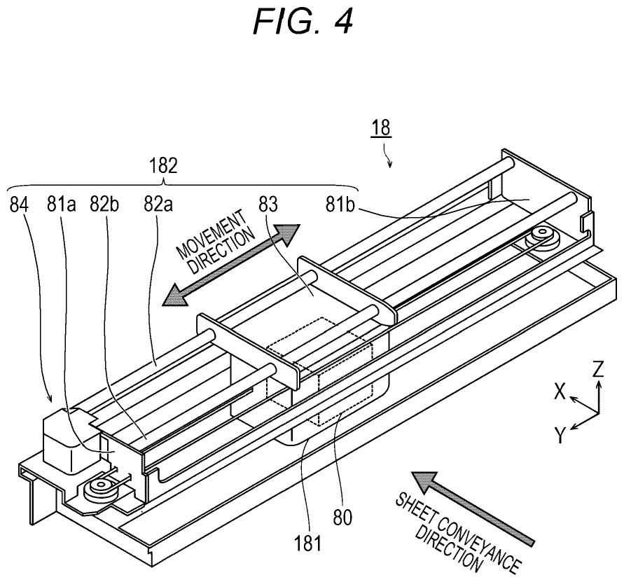

FIG. 4 is a schematic perspective view illustrating a configuration of the image color measurement section 18. The image color measurement section 18 includes a head 181 in which a spectrophotometric colorimeter is built, and a movement mechanism 182 that moves the head 181 and the colorimeter 80 inside the head 181 in the width direction. The colorimeter 80 built in the head 181 irradiates an image formed on the sheet with light from a specific light source, detects the spectral reflectance of the reflected light for each wavelength, and reads the color of the image formed on the sheet (measures the color). The colorimeter 80 outputs a Lab value to the controller 11 as a result of the color measurement. The Lab value represents a color as a numerical value by a combination of (L*, a*, b*) in the L*a*b* color space. Further, as the light source, D50 (light having a color temperature of 5000 K), a light source A (light having a color temperature of about 2856 K), and a light source A (UV filter) provided with a filter for removing UV components from the light source A are selectable. The color measurement diameter (spot diameter) at the time of color measurement is several millimeters, for example, 8 mm. The size of a patch image, which will be described later, is set to a size including the color measurement diameter.

The movement mechanism 182 includes two support sections 81a and 81b attached to the housing, a pair of guide rails 82a and 82b supported by the support sections and extending along the Y direction (CD direction), and a slider 83 slidably attached to the guide rails 82a and 82b. The head 181 is mounted on the slider 83 so as to be movable in the width direction. The colorimeter 80 is built in the head. The slider 83 is driven by a driver 84 including a motor, a pulley, a belt, and the like.

### First and Second Color Measurement Modes

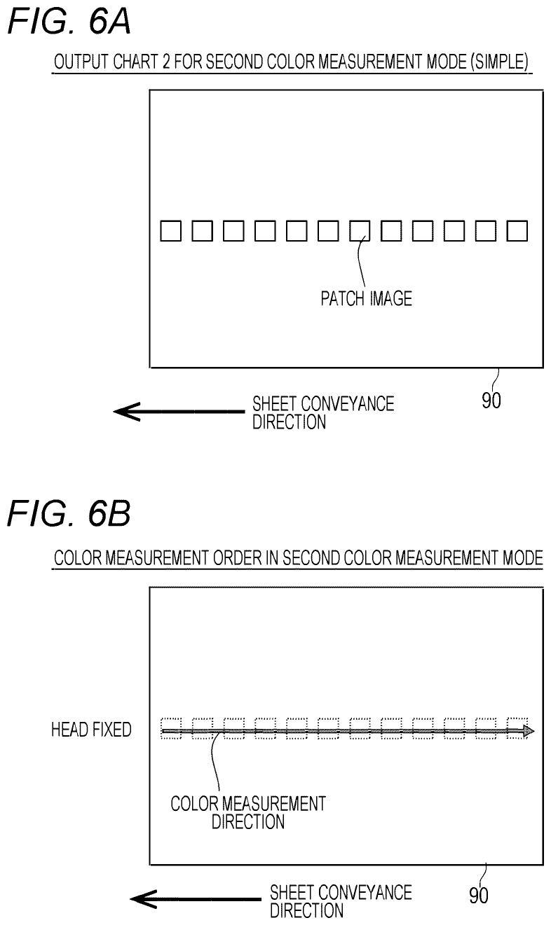

Next, the color measurement by the image color measurement section 18 will be described with reference to FIGS. 5A, 5B, and 6.

FIGS. 5A and 5B are schematic diagrams for describing a first color measurement mode; FIG. 5A illustrates a sheet 90 on which an image has been formed using an output chart 1 used in the first color measurement mode. The first color measurement mode is also referred to as a high-precision color measurement mode. In the first color measurement mode, a plurality of (approximately 100 or more) patch images having different color combinations and color densities are arranged over the entire surface of the sheet 90, and color management is performed based on the results of the color measurement. For example, a profile (also referred to as an image forming profile) of the image forming apparatus 100 is generated (updated) based on the color measurement result. The profile is, for example, a lookup table for determining an output signal of YMCK with respect to an input image signal based on print data, and is used for correcting the output of the image former 16.

Examples of the output chart 1 include a color measurement chart of the Japan Color standard. The color measurement chart of the Japan Color standard has many (1617) color measurement patches, and thus more accurate color management can be performed. However, the color measurement chart formed in the color measurement region is not limited to the color measurement chart of the Japan Color standard, and may be a chart including a smaller number of patches than the color measurement chart of the Japan Color standard. Note that the size of each patch image is set to be slightly larger than the color measurement diameter (spot diameter) as described above. FIG. 5A illustrates an example in which a plurality of patch images is arranged on one sheet 90, but the number of patches that can be arranged on one sheet is limited, and therefore the output chart 1 is output over a plurality of sheets 90 according to the size of the cut sheet.

FIG. 5B is a diagram illustrating a color measurement order of patch images in the first color measurement mode. In FIG. 5B, the patch image is indicated by a broken line for visibility. In the output chart 1 used in the first color measurement mode, the patch images are arranged over the entire surface of the sheet 90. Therefore, at the time of color measurement, the head 181 of the image color measurement section 18 measures the colors of the patch images while being reciprocated in the width direction by the movement mechanism 182. Specifically, when the patch images in the front row of the sheet 90 reach directly below the head 181 in the conveyance path 147, the sheet 90 temporarily stops. Then, the head 181 is sequentially moved over the plurality of patch images in the front row from one end portion to the other end portion in the width direction to measure the colors of the plurality of patch images with the built-in colorimeter 80. Thereafter, the sheet 90 is slightly moved to a position where the patch images of the next row are directly below the head 181, and the head 181 is sequentially moved in the direction opposite to the direction for the front row from one end portion to the other end portion in the width direction to measure the colors of the plurality of patch images. These operations are repeated, and thus the colors of the patch images on the entire surface of the sheet 90 are measured. This process is repeated in a case where the color measurement is performed for a plurality of sheets 90.

FIG. 6 is a schematic diagram for describing a second color measurement mode; FIG. 6A illustrates a sheet 90 on which an image has been formed using an output chart 2 used in the second color measurement mode. The second color measurement mode is also referred to as a simple color measurement mode, and the number of patch images to be subjected to the color measurement is smaller than that in the first color measurement mode. In addition, in the output chart 2 used in the second color measurement mode, a plurality of (approximately a dozen or so) patch images having different color combinations and color densities are arranged in the vertical direction (conveyance direction) over a part of the sheet 90 so that the head 181 does not need to be moved. Then, color management is executed on the basis of the color measurement result. For example, based on the color measurement result, it is confirmed whether or not the color output of the image forming apparatus 100 is satisfactory (inspection). In a case where there is a problem such as a case where the color is out of the specified range, an error is issued or a notification for prompting the execution of the first color measurement mode is provided.

FIG. 6B is a diagram illustrating a color measurement order of patch images in the second color measurement mode. In FIG. 6B, the patch image is indicated by a broken line for visibility. In the second color measurement mode, in the output chart 2, the patch images are arranged so as to be vertically aligned in a part of the sheet 90. Therefore, the head 181 of the image color measurement section 18 is fixed at the time of the color measurement. The colors of a plurality of patch images arranged vertically are measured with the colorimeter 80 while moving or temporarily stopping the sheet 90.

### Post-Processor 19

As described above, the post-processor 19 is disposed in the post-processing device 500. The post-processor 19 performs at least one of stapling, punching, cutting, folding, or bookbinding on the sheet 90 on which an image has been formed.

### Communicator 20

The communicator 20 is an interface for communicating with other devices.

### Environment Sensor 21

The environment sensor 21 measures an environment around the color measurement system 1000. The environment sensor 21 includes a temperature sensor and a humidity sensor which are disposed inside a housing of the color measurement system 1000, and measures temperature and humidity.

### Timer 22

The timer 22 is a real-time clock (RTC), and has a function of outputting the current date and time and a time measuring function. The time lag may be corrected by using a network time protocol (NTP).

### History Data

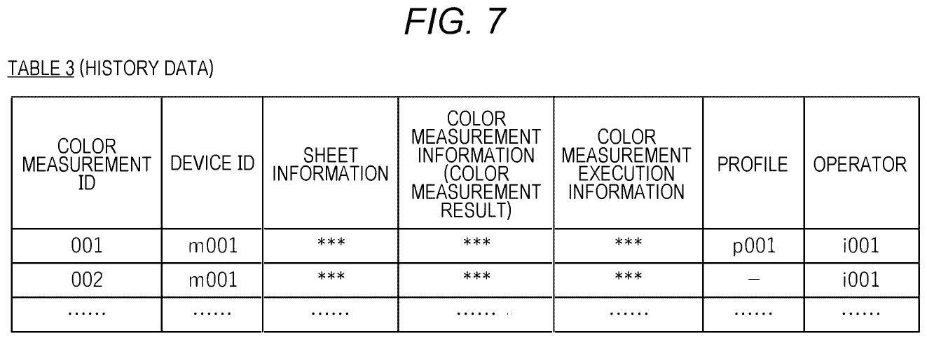

Next, history data stored in the history data DB of the storage 12 will be described. Table 3 in FIG. 7 is an example of history data. The history data includes a color measurement ID, a device ID of the color measurement system 1000, sheet information, color measurement information, color measurement execution information, a profile, and the ID of an operator who has given the color measurement execution instruction. The color measurement IDs are main keys and are automatically numbered each time color measurement is performed in either the first or second color measurement mode. One history data is created for each color measurement ID.

The detail of the sheet information is as illustrated in Table 2 of FIG. 3. The sheet information is the sheet information regarding the sheet 90 on which the color measurement has been performed, and is associated with the history data read from the storage 12.

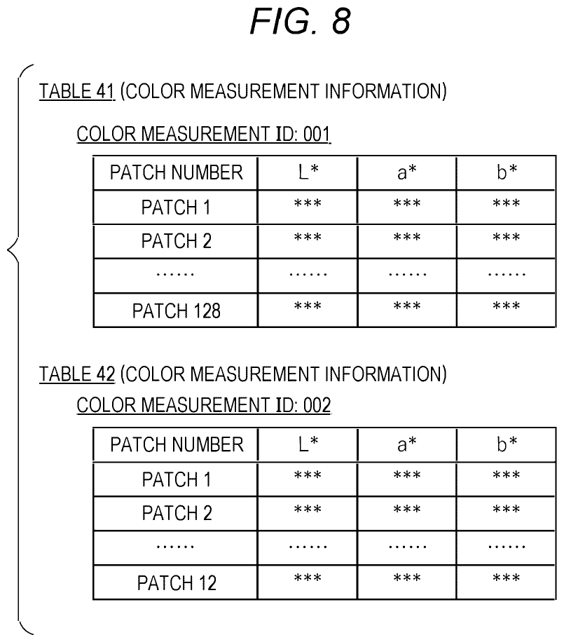

The color measurement information is a color measurement result. Table 41 illustrated in FIG. 8 indicates the color measurement results of the patch images that have been subjected to the color measurement in the first color measurement mode with the color measurement ID 001. Measurement results corresponding to 128 patch images are recorded. Table 42 illustrated in FIG. 8 indicates color measurement results of 12 patch images that have been subjected to the color measurement in the second color measurement mode with the color measurement ID 002.

Note that the numbers 128 and 12 of patch images in Tables 41 and 42 are merely examples. In Table 41, the color measurement values of 1000 or more patch images may be recorded, and in Table 42, the color measurement values of a smaller number of patch images, for example, several patch images may be recorded.

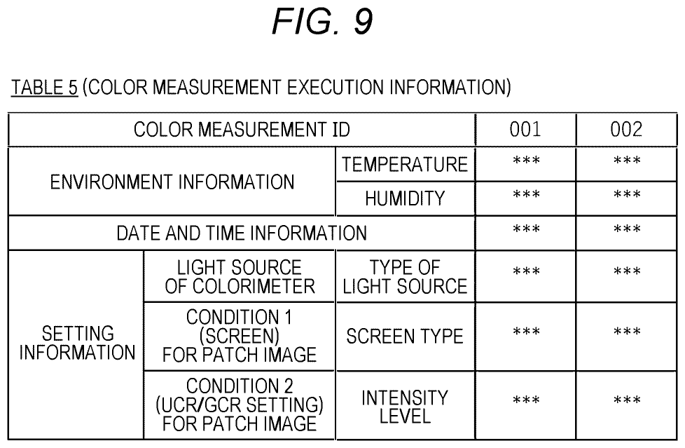

The color measurement execution information indicated in Table 5 in FIG. 9 is accompanying information (metadata) related to the execution of the color measurement. The color measurement execution information includes at least one of environment information, date and time information, and setting information. The environment information is data detected by the environment sensor 21 during the execution of the color measurement. The date and time information is data output by the timer 22 during the execution of the color measurement. The setting information is data set by the user using the operation display 15 or the like at the time of performing color measurement. The setting information includes the type of the light source of the colorimeter 80 and conditions 1 and 2 for the patch image. As described above, there are three types of light sources: D50, the light source A, and the light source A with a UV filter.

The condition 1 for a patch image is a screen type setting for output by the image former 16, and includes a screen for expressing colors of intermediate density with dots and a screen for expressing colors of intermediate density with lines. The condition 2 for a patch image is intensity setting for under color removal (UCR)/gray component replacement (GCR), and replaces the YMC color signals with the K color signal. As the intensity is higher, more YMC toner is replaced with K toner, whereby cost can be reduced.

### Color Measurement Method

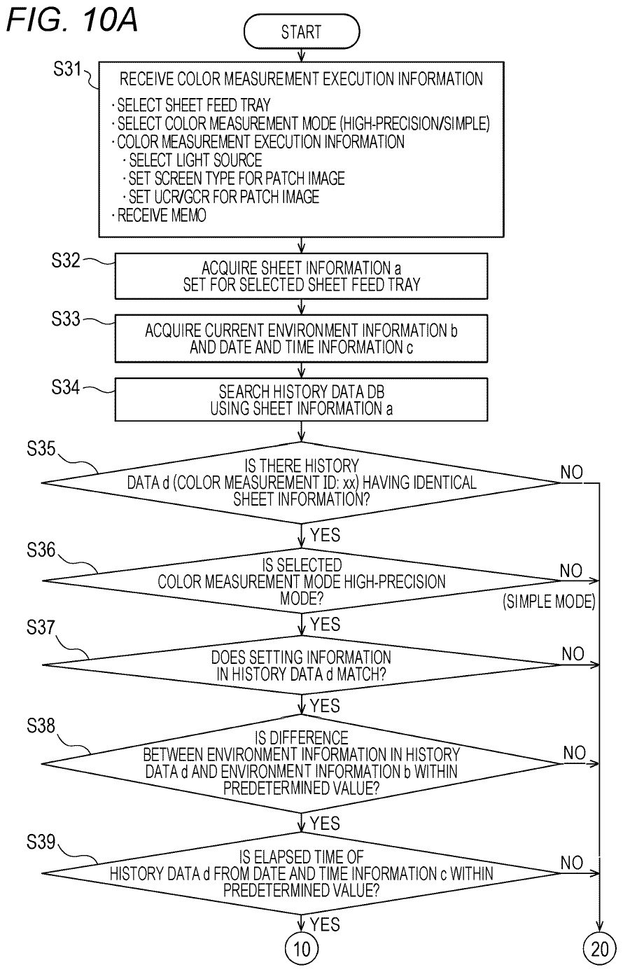

Next, the color measurement method executed in the present embodiment will be described with reference to FIGS. 10A and 10B. FIG. 10A is a flowchart illustrating the color measurement method. FIG. 10B is a flowchart to be executed subsequent to FIG. 10A.

### Step S31

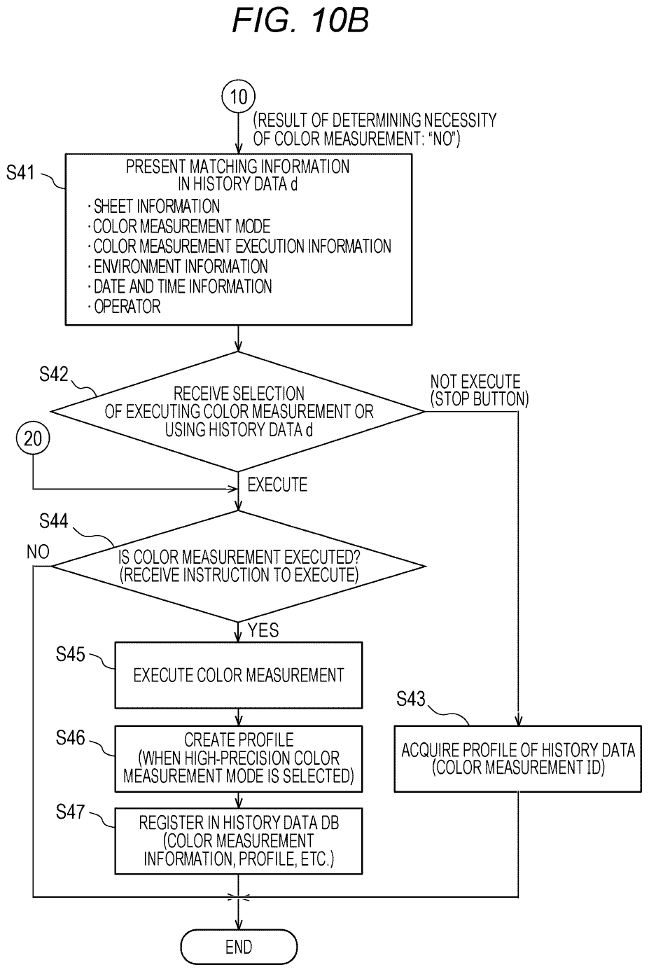

In this step, the controller 11 receives input of the color measurement execution information from the user through the operation display 15. FIG. 11 is an example of various operation screens displayed on the operation display 15 used in the process of step S31.

As illustrated in an operation screen d1 in FIG. 11, first, the selection of a sheet feed tray is received. Next, the selection of the high-precision color measurement mode (first color measurement mode) or the simple color measurement mode (second color measurement mode) is received through an operation screen d2. In FIG. 11, the high-precision color measurement mode is selected. Next, the type of light source in the setting information is received as the color measurement execution information through an operation screen d3. Thereafter, the conditions 1 and 2 for the patch image are sequentially received through operation screens d4 and d5. In addition, a text input of a note may be received.

### Step S32

Next, the controller 11 acquires, from the storage 12, sheet information (hereinafter, referred to as sheet information a) associated with the sheet feed tray selected in step S31 (see FIG. 3).

### Step S33

Next, the controller 11 acquires current environment information and date and time information from the environment sensor 21 and the timer 22 (hereinafter, referred to as environment information b and date and time information c).

### Step S34

The controller 11 searches the history data DB of the storage 12 using the sheet information a, and determines whether or not there is history data having sheet information matching the sheet information a. The matching of the sheet information indicates a case where the sheet type and the basis weight category are the same. The basis weight category is determined by a determination value of the basis weight sensor 2. Furthermore, the matching of the sheet information indicates a case where all of the physical property values (physical properties 1 to 6) of the sheet physical properties fall within an allowable error value that is within 20%. That is, when the sheet information in the history data d that is searched for has physical property values all of which fall within values in a range within ±20% from the physical property values in the sheet information a, this sheet information is determined to match the sheet information a.

### Step S35

The history data DB is searched, and when there is history data (hereinafter referred to as history data d or past history information) whose sheet information matches (YES), the processing proceeds to step S36, and when there is no such history data (NO), the processing proceeds to step S44 (denoted by circled number 20).

### Step S36

When the color measurement mode selected in step S31 is the high-precision color measurement mode (first color measurement mode) (YES), the controller 11 advances the processing to step S37, and when the color measurement mode is the simple color measurement mode (second color measurement mode) (NO), the controller 11 advances the processing to step S44 (denoted by circled number 20).

### Step S37

The controller 11 determines whether the setting information in the history data d matches the setting information indicating the color measurement conditions input in step S31. Specifically, the controller 11 determines whether or not the selected light source, screen type, and UCR/GCR setting in the setting information in the history data d match the setting information input in step S31. If all are the same (YES), the processing proceeds to step S38, and if any one of the settings is not the same (NO), the processing proceeds to step S44 (denoted by circled number 20).

### Step S38

The controller 11 compares the environment information in the history data d with the current environment information b, and if the difference is within a predetermined value (e.g., within ±20%) (YES), the processing proceeds to step S39. On the other hand, if any one of them is not the same (NO), the processing proceeds to step S44 (indicated by circled number 20).

### Step S39

The controller 11 compares the date and time information in the history data d with the date and time information c at the current time, and if the elapsed time from the date and time information in the history data d is within a predetermined value (for example, within one week) (YES), the controller 11 advances the processing to step S41 (indicated by circled number 10). On the other hand, if any one of them is not the same (NO), the processing proceeds to step S44 (indicated by circled number 20).

### Step S41

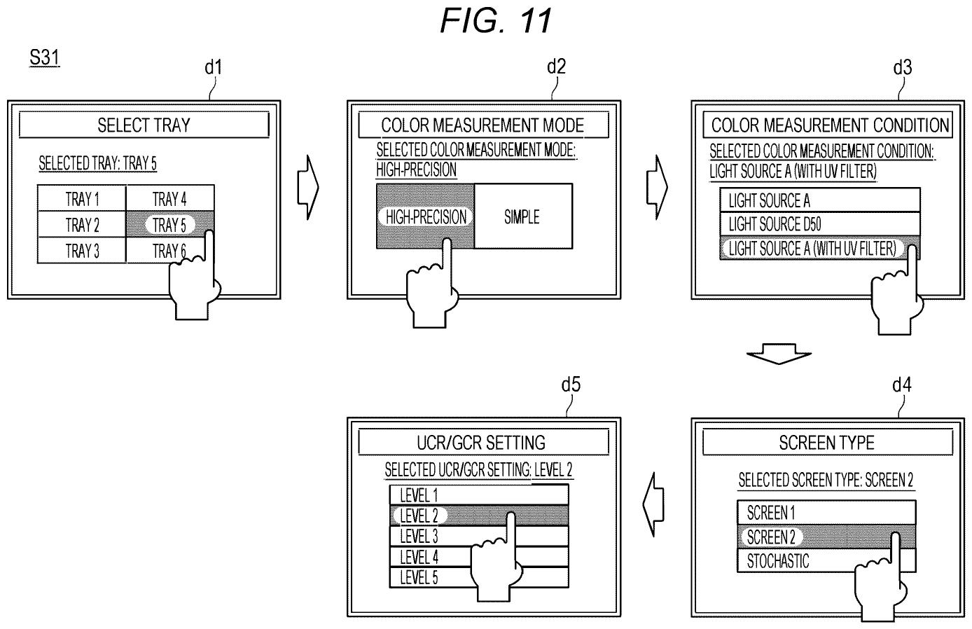

In step S41 of FIG. 10B, various kinds of information in the history data d is displayed. An operation screen d6 illustrated in FIG. 12 is a display example of various kinds of information. As the various kinds of information, the color measurement mode executed in the history data d (past history information), the execution date and time, the operator, the environment information, the sheet information, and the like are displayed. Note that the setting information and the values of the sheet physical properties may also be displayed in a scrollable view or the like.

### Step S42

In this step, the controller 11 receives selection, from the user, of either executing color measurement or using history data. When an “execute” button is pressed on the operation screen d6 in FIG. 12 (execute), the processing proceeds to step S44. On the other hand, when a “stop” button is pressed on the operation screen d6 (not execute), the processing proceeds to step S43.

### Step S43

In this step, the controller 11 acquires a profile associated with the history data d (reuse). Note that in this step, the controller 11 may obtain the past color measurement results associated with the history data d and create a new profile using these results.

### Step S44

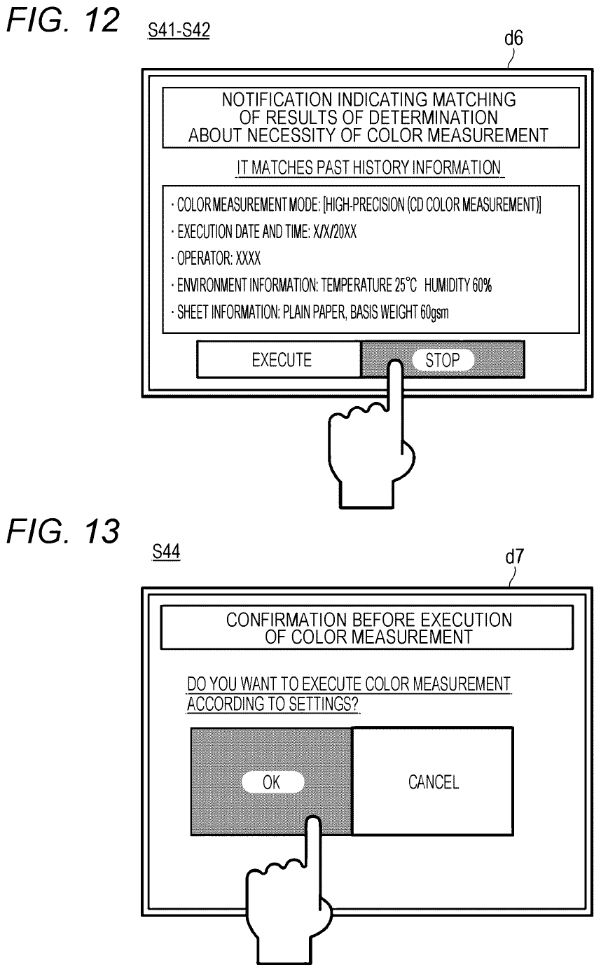

In this step, the controller 11 receives, again from the user, a selection as to whether to perform color measurement. When an OK button is pressed on an operation screen d7 in FIG. 13 (YES), the processing proceeds to step S45. When a cancel button is pressed (NO), the processing is stopped without performing the color measurement (end)

### Step S45

The color measurement system 1000 conveys the sheet 90 from the sheet feed tray set in step S31, and performs color measurement in the color measurement mode set in step S31.

### Step S46

The controller 11 creates a profile based on the color measurement result obtained in step S45. Note that the profile is created when the color measurement mode executed in step S45 is the high-precision color measurement mode, and no profile is created in the simple color measurement mode.

### Step S47

The controller 11 assigns a new color measurement ID to the history data DB, associates the new color measurement ID with a series of pieces of information including the sheet information, the color measurement execution information, the color measurement information, and the profile, registers the associated information as history data in the history data DB of the storage 12, and ends the color measurement processing (END). Thereafter, image formation is performed using the newly created profile (or the reused profile).

As described above, the color measurement system according to the present embodiment includes an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement. Furthermore, the color measurement system includes: a sheet information acquirer that acquires sheet information about the sheet to be subjected to color measurement; a storage that stores color measurement information obtained by the color measurement by the image color measurement section in association with the sheet information as history data; and a controller that, when receiving a color measurement instruction, determines whether or not the color measurement by the image color measurement section is necessary based on the sheet information about the sheet to be subjected to the color measurement and the history data. Thus, it is possible to appropriately determine whether or not the color measurement by the color measurement section is necessary while suppressing consumption of resources and a load on the system.

The main configurations of the color measurement device 400 and the color measurement system 1000 including the same have been described above for describing the features of the above embodiment, and the configurations of the color measurement device 400 and the color measurement system 1000 including the same described above are not limited to the above-mentioned configurations, and can be modified in various manners within the scope of the claims. Furthermore, the descriptions above are not intended to exclude any configuration included in a general image forming apparatus.

In addition, means and methods for performing the various processes in the color measurement system 1000 according to the above-described embodiment can be implemented by any of a dedicated hardware circuit and a programmed computer. The program described above may be provided by, for example, a computer-readable storage medium such as a USB memory or a digital versatile disc (DVD)-ROM, or may be provided online via a network such as the Internet. In this case, the program recorded on the computer-readable storage medium is usually transferred to and stored in a storage such as a hard disk. In addition, the above program may be offered as standalone application software or may be incorporated, as a function of an apparatus, into software for the apparatus.

While the embodiment of the present invention has been described and illustrated in detail, the disclosed embodiment has been created for purposes of illustration and example only, and not limitation. The scope of the present invention is to be interpreted by the wording of the appended claims.

1. A color measurement system comprising:
an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement;
a sheet information acquirer that acquires sheet information about the sheet to be subjected to color measurement;
a storage that stores color measurement information obtained by the color measurement by the image color measurement section in association with the sheet information as history data; and
a hardware processor that, when receiving a color measurement instruction, determines whether or not the color measurement by the image color measurement section is necessary based on the sheet information about the sheet to be subjected to the color measurement and the history data.

2. The color measurement system according to claim 1, wherein, when receiving the color measurement instruction, the hardware processor determines, based on the sheet information about the sheet to be subjected to color measurement, whether or not the color measurement information associated with identical sheet information is present in the history data,
determines not to perform the color measurement when the color measurement information is present, and
determines to perform the color measurement when the color measurement information is not present.

3. The color measurement system according to claim 1, further comprising an image former that forms an image on a sheet, wherein the image former forms the plurality of patch images on the sheet when the color measurement is performed.

4. The color measurement system according to claim 3, wherein the history data is associated with a profile that is generated based on the color measurement information and that is used for correcting an output of the image former.

5. The color measurement system according to claim 4, wherein, when determining not to perform the color measurement due to the color measurement information associated with identical sheet information being present in the history data,
the hardware processor reads the profile from the history data in the storage and uses the read profile for image formation by the image former.

6. The color measurement system according to claim 1, wherein the sheet information includes information about a sheet type or a sheet physical property.

7. The color measurement system according to claim 6, wherein the sheet physical property includes at least one of stiffness, basis weight, sheet thickness, moisture content, surface property, and sheet resistance of the sheet.

8. The color measurement system according to claim 1, wherein the history data is stored in association with color measurement execution information, and
the color measurement execution information includes at least one of environment information indicating a temperature and/or humidity when color measurement is executed, date and time information when color measurement is executed, and setting information indicating a color measurement condition for the color measurement.

9. The color measurement system according to claim 8, wherein, when receiving the color measurement instruction, the hardware processor acquires the sheet information about the sheet to be subjected to color measurement and the environment information indicating a current temperature and/or humidity,
determines whether or not history data in which the sheet information is identical and a difference between the current environment information and the environment information upon execution of the color measurement is equal to or less than a predetermined value is present,
determines not to perform the color measurement when the history data is present, and
determines to perform the color measurement when the history data is not present.

10. The color measurement system according to claim 8, further comprising a timer, wherein,
when receiving the color measurement instruction,
the hardware processor acquires the sheet information about the sheet to be subjected to color measurement and the date and time information indicating a current date and time,
determines whether or not history data in which the sheet information is identical and an elapsed time from the date and time information upon execution of the color measurement is equal to or less than a predetermined value is present,
determines not to perform the color measurement when the history data is present, and
determines to perform the color measurement when the history data is not present.

11. The color measurement system according to claim 1, wherein
the image color measurement section is capable of executing a first color measurement mode and a second color measurement mode having a smaller number of patch images to be subjected to color measurement than the first color measurement mode,
in the first color measurement mode, the image color measurement section moves the colorimeter in the width direction orthogonal to the conveyance direction of the sheet and moves the sheet in the conveyance direction to read a plurality of patch images arranged on the sheet in the conveyance direction and the width direction to perform color measurement,
in the second color measurement mode, the image color measurement section moves the sheet in the conveyance direction with the colorimeter being fixed to read a plurality of patch images arranged on the sheet in the conveyance direction and perform color measurement,
when the color measurement in the first color measurement mode is instructed in the color measurement instruction, the hardware processor makes a determination of whether or not the color measurement by the image color measurement section is necessary based on the sheet information about the sheet to be subjected to the color measurement, and
when the color measurement in the second color measurement mode is instructed in the color measurement instruction, the hardware processor executes the second color measurement mode without making the determination.

12. A color measurement method performed by a color measurement system including an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement, and a storage that stores color measurement information obtained by the color measurement by the image color measurement section in association with sheet information about the sheet as history data, the color measurement method comprising:
a step (a) of receiving a color measurement instruction;
a step (b) of acquiring sheet information about the sheet to be subjected to color measurement; and
a step (c) of determining whether or not the color measurement by the image color measurement section is necessary based on the sheet information acquired in the step (b) and the history data.

13. The color measurement method according to claim 12, wherein the step (c) includes: determining, based on the sheet information about the sheet to be subjected to color measurement, whether or not the color measurement information associated with identical sheet information is present in the history data;
determining not to perform the color measurement when the color measurement information is present; and
determining to perform the color measurement when the color measurement information is not present.

14. A non-transitory computer-readable storage medium storing a control program executed by a color measurement system including an image color measurement section that moves a colorimeter in a width direction orthogonal to a conveyance direction of a sheet and moves the sheet in the conveyance direction to read a plurality of patch images arranged on the sheet in the conveyance direction and the width direction and perform color measurement, and a storage that stores color measurement information obtained by the color measurement by the image color measurement section in association with sheet information about the sheet as history data, the control program causing a computer to execute processing comprising:
a step (a) of receiving a color measurement instruction;
a step (b) of acquiring sheet information about the sheet to be subjected to color measurement; and
a step (c) of determining whether or not the color measurement by the image color measurement section is necessary based on the sheet information acquired in the step (b) and the history data.

15. The non-transitory computer-readable storage medium according to claim 14, wherein the step (c) includes: determining, based on the sheet information about the sheet to be subjected to color measurement, whether or not the color measurement information associated with identical sheet information is present in the history data;
determining not to perform the color measurement when the color measurement information is present; and
determining to perform the color measurement when the color measurement information is not present.
